(19) United States
(12) Patent Application Publication
(10) Pub. No.: US 2017/0090642 A1
(43) Pub. Date: Mar. 30, 2017

(54) METHOD FOR MODE SWITCHING AND DEVICE USING THE SAME

(71) Applicant: HON HAI PRECISION INDUSTRY CO., LTD., New Taipei (TW)

(72) Inventor: YU-CHEN HUANG, New Taipei (TW)

(21) Appl. No.: 14/879,922

(22) Filed: Oct. 9, 2015

(30) Foreign Application Priority Data
Sep. 25, 2015 (TW) 104131744

(51) Int. Cl. G06F 3/041

(52) U.S. Cl. CPC G06F 3/0416

(57) ABSTRACT

A mode switching device includes a first contact surface. The first contact surface includes a trigger area and is used to sense an external action. When the external action acts in the trigger area and meets a first preset condition, the mode switching device is set to a first mode. When the external action acts in the trigger area and meets a second preset condition, the mode switching device is set to a second mode.

### FIELD

The subject matter herein generally relates to a method for mode switching and a device using the same.

### BACKGROUND

Usually, people have to use buttons to switch mode of mobile devices. And buttons are used less and less in design of mobile devices.

### BRIEF DESCRIPTION OF THE DRAWINGS

Implementations of the present technology will now be described, by way of example only, with reference to the attached figures.

FIG. 1 is a diagrammatic diagram of an embodiment of a mode switching device of the present disclosure.

FIG. 2 is a flowchart diagram of an embodiment of a mode switching method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The disclosure will now be described in relation to an electronic device with a mode switching device 100.

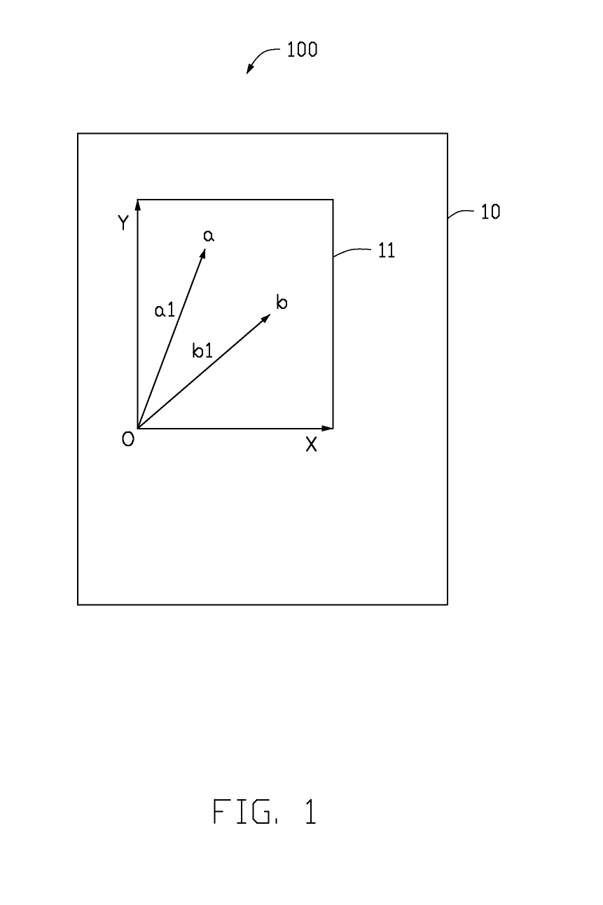

FIG. 1 shows an embodiment of a mode switching device 100 of the present disclosure. The mode switching device 100 can comprise a first contact surface 10. The first contact surface 10 can comprise a trigger area 11.

When an external action acts in the trigger area 11 and meets a first condition, the mode switching device 100 is set to a first mode.

When an external action acts in the trigger area 11 and meets a second condition, the mode switching device 100 is set to a second mode.

In the illustrated embodiment, the first contact surface is a rectangle with a height H and a width W. The trigger area 11 is a rectangle. A height of the trigger area 11 is H*½. A width of the trigger area 11 is W*⅓.

In the illustrated embodiment, a bottom line of the trigger area 11 is set to be an X axis. A left line of the trigger area 11 is set to be a Y axis. An intersection point of the X axis and the Y axis is considered as an original point 0.

When a action is acting on the first contact surface 10, the mode switching device determines whether the action is in the trigger area 11.

In the illustrated embodiment, a user uses two fingers to touch the first contact surface 10 which generates a first contact point a and a second contact point b.

A distance between the first contact point a and the original point 0 is a1. A distance between the second contact point b and the original point 0 is b1.

When both of a1 and b1 are becoming larger, the mode switching device determines that the external action meets the first condition and switches to the first mode.

When both of a1 and b1 are becoming smaller, the mode switching device determines that the external action meets the second condition and switches to the second mode.

When a1 is becoming larger and b1 is becoming smaller, the mode switching device determines that the external action meet a third condition and switches to a third mode.

In the illustrated embodiment, the mode switching device is a mobile phone. The first contact surface is a touch panel. The first mode is a silent mode. The second mode is a sound on mode. The third mode is a blocked mode. The external action is touching.

In at least one embodiment, the external action can be clicking.

In at least one embodiment, the first contact surface can be a spherical surface.

In at least one embodiment, a frequency of the external action can be used to generate condition used to switch the modes of devices.

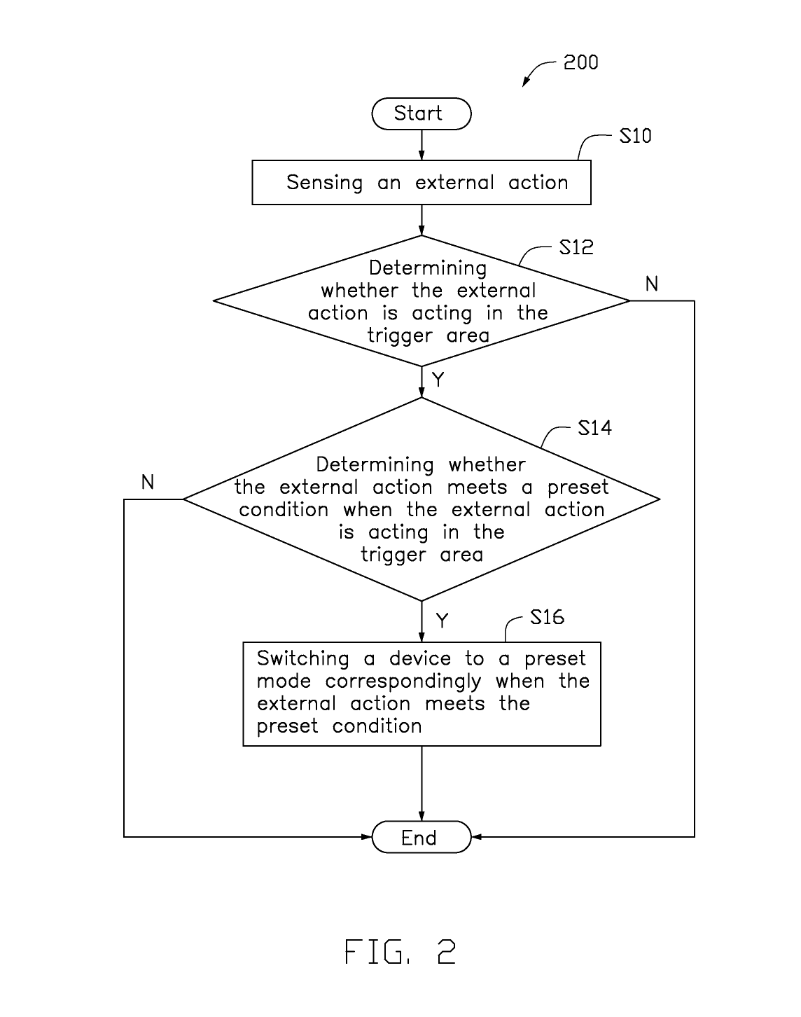

FIG. 2 illustrates a flowchart of an exemplary method 200 for switching a plurality of modes of the mode switching device 100. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block S10.

At block S10, the mode switching device 100 senses an external action.

At block S12, the mode switching device 100 determines whether the external action is acting in the trigger area.

At block S14, the mode switch device 100 determines whether the external action meets a preset condition when the external action is acting in the trigger area.

At block S16, the mode switch device 100 is set to a preset mode correspondingly when the external action meet the preset condition.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A mode switching device comprising:
a first contact surface comprising a trigger area and configured to sense an external action;
wherein in a first mode the external action acts in the trigger area and meets a first preset condition, and in a second mode the external action acts in the trigger area and meets a second preset condition.

2. The mode switching device as claim 1, wherein the external action is touching.

3. The mode switching device as claim 1, wherein the external action is clicking.

4. The mode switching device as claim 1, wherein the first contact surface is a spherical surface.

5. The mode switching device as claim 1, wherein the first contact surface is a rectangle.

6. The mode switching device as claim 1, wherein the first mode is a silent mode.

7. A mode switching method, comprising:
sensing an external action;
determining whether the external action is acting in the trigger area;
determining whether the external action meets a preset condition when the external action is acting in the trigger area; and
switching a device to a preset mode correspondingly when the external action meets the preset condition.
